(19) United States
(12) Patent Application Publication
(10) Pub. No.: US 2025/0294611 A1
(43) Pub. Date: Sep. 18, 2025

(54) LOW POWER INDOOR (LPI) ACCESS POINT (AP) CLEAR CHANNEL ASSESSMENT (CCA) SIGNALING SCHEMES FOR SEAMLESS PREAMBLE PUNCTURING SUPPORT

(71) Applicant: Cisco Technology, Inc., San Jose, CA (US)

(72) Inventors: Nedime Pelin Mohamed Hassan Salem, San Jose, CA (US); Brian D. Hart, Sunnyvale, CA (US)

(21) Appl. No.: 19/080,198

(22) Filed: Mar. 14, 2025

Related U.S. Application Data
(60) Provisional application No. 63/565,271, filed on Mar. 14, 2024.

(51) Int. Cl. H04W 74/0816; H04L 1/00; H04W 8/22; H04W 48/02

(52) U.S. Cl. CPC H04W 74/0816; H04L 1/0068; H04W 8/22; H04W 48/02

(57) ABSTRACT

A Low Power Indoor (LPI) Access Point (AP) Clear channel Assessment (CCA) signaling schemes for seamless preamble puncturing support may be provided. An AP may signal a first indication that the AP supports punctured subchannel CCA. The AP may receive a second indication from a station whether the station supports the punctured subchannel CCA. The AP may determine a nature of association between the AP and the station based on the second indication.

### RELATED APPLICATION TECHNICAL FIELD

Under provisions of 35 U.S.C. § 119(e), Applicant claims the benefit of U.S. Provisional Application No. 63/565,271 filed Mar. 14, 2024, which is incorporated herein by reference.

### TECHNICAL FIELD

The present disclosure relates generally to providing a Low Power Indoor (LPI) Access Point (AP) Clear channel Assessment (CCA) signaling schemes for seamless preamble puncturing support.

### BACKGROUND

In computer networking, a wireless Access Point (AP) is a

networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing a Low Power Indoor (LPI) Access Point (AP) Clear channel Assessment (CCA) signaling schemes for seamless preamble puncturing support;

FIG. 2 is a flow chart of a method for providing a LPI AP CCA signaling schemes for seamless preamble puncturing support; and

FIG. 3 is a block diagram of a computing device.

### DETAILED DESCRIPTION

### Overview

A Low Power Indoor (LPI) Access Point (AP) Clear channel

Assessment (CCA) signaling schemes for seamless preamble puncturing support may be provided. An AP may signal a first indication that the AP supports punctured subchannel CCA. The AP may receive a second indication from a station whether the station supports the punctured subchannel CCA. The AP may determine a nature of association between the AP and the station based on the second indication.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Low Power Indoor (LPI) and Standard Power (SP) are two classes of Wi-Fi Access Points (APs) that differ in their power levels and how they operate. LPI APs may be designed for fixed indoor use and operate at lower power levels. The APs may be intended to minimize interference and optimize spectrum utilization in dense indoor environments. LPI APs may be required to be installed in a fixed location, have permanently attached antennas, and be powered by a wired connection. SP APs may operate indoors or outdoors at full power. They may be designed to provide extended coverage and range, making them suitable for larger indoor spaces and outdoor deployments. SP APs may be controlled by an Automated Frequency Coordination (AFC) database to mitigate interference with other services (i.e., incumbents).

Consider an LPI AP operating an 80 MHz Basic Service Set (BSS) made up of four 20 MHz subchannels that may be designated by [P20, S20, S40a, S40b] (e.g., lowest to highest frequency ordering). There may be an incumbent on the S40a subchannel. Puncturing in the Institute of Electrical and Electronics Engineers (IEEE) 802.11ax/be standard (i.e., sensing a clear channel on [P20, S20, x, S40b] then transmitting on [P20, S20, x, S40b], but not sensing or transmitting on [x, x, S40a, x]) was designed to transmit around the incumbent while avoiding causing interference to the incumbent. However, this process was rejected by the United States (US) Federal Communications Commission (FCC) for LPI APs. The FCC prohibits LPI APs from puncturing their channels because, in their view, puncturing may not protect incumbents.

This may be inconsistent because the LPI AP is already allowed to transmit at LPI power over the full 80 MHZ, so puncturing S40a may comprise a courtesy. However, the FCC's reasoning is that the LPI APs (and their client devices) need to perform contention-based channel access, so given any decent interference power over S40a (e.g., and it is spectrally clean so is not seen over P20/S20/S40b), the client devices may have to defer, albeit transmit on the P40 (i.e., [P20 S20]) and create “one-sided” interference that may be a minor improvement over the two-side interference from a [P20, S20, x, S40b] transmission. Therefore embodiments of the disclosure may seek a way for an LPI AP to transmit on [P20, S20, x, S40b] while still protecting incumbents. Embodiments of the disclosure provide a CCA capability and type signaling scheme through two proposed flags to enable LPI APs to use punctured channels in a way that satisfies regulators and is implementable by Wi-Fi devices, without losing usable spectrum in the unused portion of the punctured channels, preventing legacy STAs from using this scheme as they don't have the necessary CCA implemented. The disclosure further enables signaling relaxing (raising) the Clear Channel assessment (CCA) threshold over a punctured channel by an amount related to the depth of the Transmit (TX) Power Spectral Density (PSD) suppression over the punctured channel.

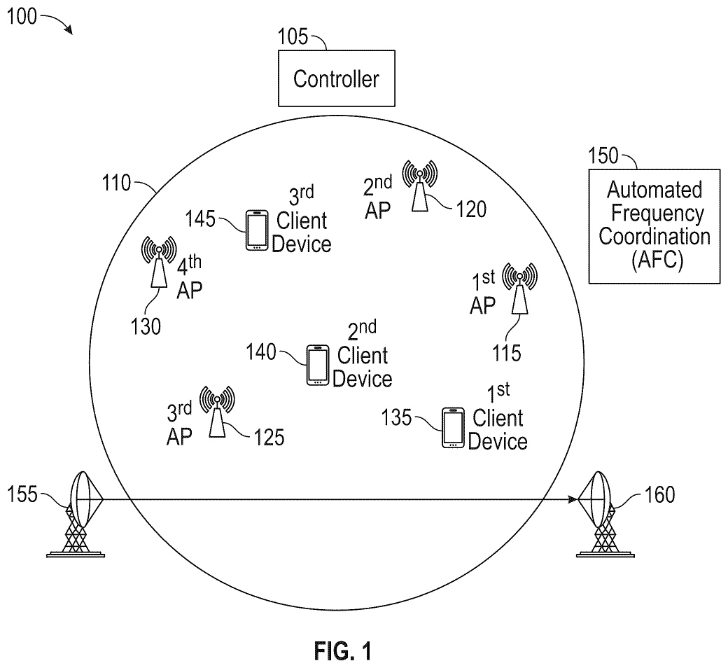

FIG. 1 shows an operating environment 100 for providing a LPI AP CCA signaling schemes for seamless preamble puncturing support. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125, and a fourth AP 130. The plurality of APs may provide wireless network access to a plurality of client devices as they move within coverage environment 110. The plurality of client devices may comprise, but are not limited to, a first client device 135, a second client device 140, and a third client device 145. Ones of the plurality of client devices may comprise, but are not limited to, a smart phone, a personal computer, a tablet device, a mobile device, a telephone, a remote control device, a set-top box, a digital video recorder, an Internet-of-Things (IOT) device, a network computer, a router, Virtual Reality (VR)/Augmented Reality (AR) devices, or other similar microcomputer-based device. Each of the plurality of APs may be compatible with specification standards such as, but not limited to, the IEEE 802.11 specification standard for example.

The plurality of APs and the plurality of client devices may use Multi-Link Operation (MLO) where they simultaneously transmit and receive across different bands and channels by establishing two or more links to two or more AP radios. These bands may comprise, but are not limited the 2 GHz band, the 5 GHz band, the 6 GHz band, and the 60 GHz band.

Controller 105 may comprise a Wireless Local Area Network controller (WLC) and may provision and control coverage environment 110 (e.g., a WLAN). Controller 105 may allow first client device 135, second client device 140, and third client device 145 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide a LPI AP CCA signaling schemes for seamless preamble puncturing support.

In order for unlicensed devices (e.g., Wi-Fi devices such as client devices and APs) to work with the licensed users already occupying a band (e.g., the 6 GHz band), AFC was established. AFC is a spectrum use coordination system. For example, because the 6 GHz band was already occupied by incumbent users (i.e., Fixed Services (FS)), such as fixed satellite providers, restrictions may be placed on the

Wi-Fi devices looking to transmit in this band. To avoid potential interference with existing 6 GHz incumbents, AFC may impose two types of device classifications with different transmit power rules for Wi-Fi devices operating on the band: i) low power APs for indoor Wi-Fi and ii) standard power APs that may be used indoors and outdoors.

As shown in FIG. 1, AFC 150 may provide spectrum use coordination for coverage environment 110. A transmitter 155 and a receiver 160 may comprise a licensed FS incumbent user. First AP 115, second AP 120, third AP 125, and fourth AP 130 may comprise unlicensed devices. AFC 150 may coordinate spectrum use between the licensed and unlicensed to avoid potential interference in coverage environment 110.

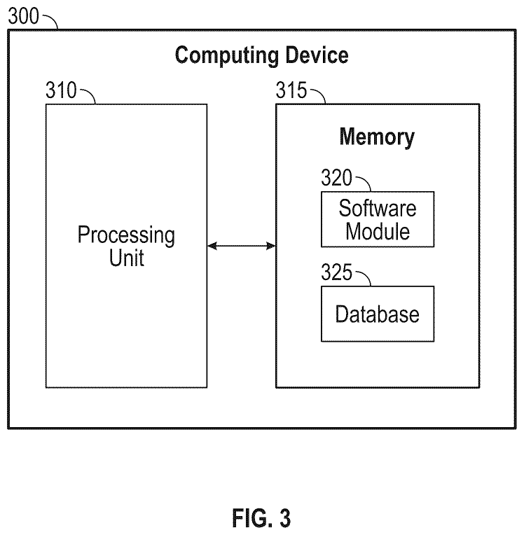

The elements described above of operating environment 100 (e.g., controller 105, first AP 115, second AP 120, third AP 125, fourth AP 130, first client device 135, second client device 140, or third client device 145) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

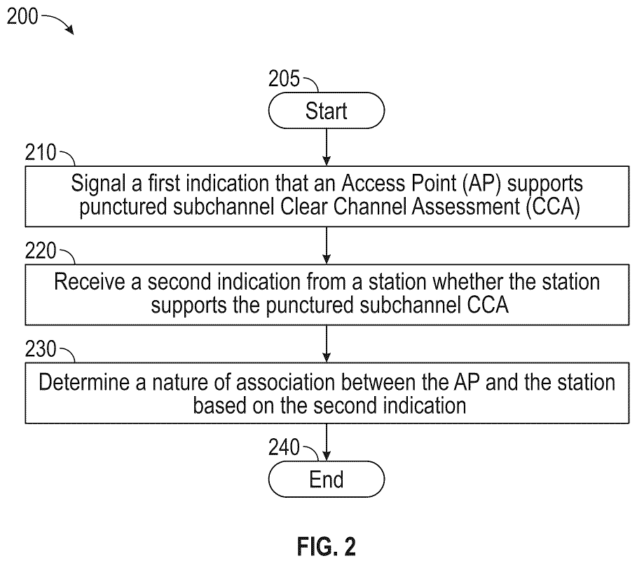

FIG. 2 is a flow chart setting forth the general stages involved in a method 200 consistent with embodiments of the disclosure for providing a LPI AP CCA signaling schemes for seamless preamble puncturing support. Method 200 may be implemented using first AP 115 as described in more detail below with respect to FIG. 1. However, method 200 may be implemented by any of controller 105, the plurality of APs, or the plurality of client devices of operating environment of FIG. 1 for example. Ways to implement the stages of method 200 will be described in greater detail below.

Method 200 may begin at starting block 205 and proceed to stage 210 where first AP 115 may signal a first indication that the AP supports punctured subchannel CCA. AP 115 may signal the first indication in an Extremely High Throughput (EHT) operation element or in an Ultra High Reliability (UHR) operation element. The EHT/UHR operation element may include a punctured subchannel CCA required field. In one example, the punctured subchannel CCA required field may be 1 bit long. The bit in the punctured subchannel CCA required field is set by first AP 115 to a first value (for example, 0) if first AP 115 does not require punctured subchannel CCA to be performed. The bit in the punctured subchannel CCA required field may be set by first AP 115 to a second value (for example, 1) if first AP does require punctured subchannel CCA to be performed by itself and its associated clients whenever STAs (AP or clients) are exploring whether to transmit on a punctured subchannel. An LPI AP in the US in the current regulatory environment in a BSS with preamble puncturing may set the bit in the punctured subchannel CCA required field to the second value (that is, 1).

After signaling the first indication that the AP supports the punctured subchannel CCA at stage 210, method 200 proceeds to stage 220 where first AP 115 may receive a second indication from a station whether the station supports the punctured subchannel CCA. The station may be another AP or a client device. The station may signal the second indication in an EHT capability element or in an UHR capability element. The EHT/UHR capability element may include a punctured subchannel CCA field. In one example, the punctured subchannel CCA field may be 1bit long. The bit in the punctured subchannel CCA field may be set to a first value (for example, 0) if the station is performing traditional sensing where it may be capable of sensing around the punctured subchannel but does not perform CCA for the punctured subchannel. The bit in the punctured subchannel CCA field may be set to a second value (for example, 1) if the station may perform CCA sensing over both punctured and unpunctured subchannels. The station may perform CCA sensing over both punctured and unpunctured subchannels when the station may be exploring whether to transmit on those subchannels, except, if the station may lower its emissions over a punctured subchannel by a relaxation value (for example, X dB), then the station can relax (or raise) its CCA threshold by X dB for that punctured subchannel.

Once having received the second indication from the station whether the station supports the punctured subchannel CCA at stage 230, method 200 proceeds to stage 230 where first AP 115 may determine a nature of association between first AP 115 and the station based on the second indication. In one example, first AP 115 may disallow the station to associate with first AP 115 in response to the second indication indicating that the station does not support the punctured subchannel CCA. In another example, first AP 115 may allow the station to associate with first AP 115 at a lower bandwidth that is entirely unpunctured in response to the second indication indicating that the station does not support the punctured subchannel CCA. In yet another example, first AP 115 may allow the station to associate with first AP 115 at a full bandwidth that includes punctured channels in response to the second indication indicating that the station does support the punctured subchannel CCA.

In example embodiments, in order to support a legacy client device that may not understand the punctured subchannel CCA required field, first AP 115 may disallow association of the legacy client device that do not indicate capability or signal the punctured subchannels in a way not understood by the legacy client device. So, the legacy client device may only see the option for a narrower-bandwidth contiguous channel bandwidth.

As discussed above, in some examples, only a client device that supports the required behavior may be permitted to associate with and operate at the full bandwidth that includes punctured channels. Otherwise, the client device may join at and operate at a lower bandwidth that is entirely unpunctured. Thus, proposed signaling may allow station classification and recognition for rejecting association if the client's capability is insufficient.

In example, embodiments the relaxation value (that is, X) may also be signaled. As discussed above first AP 115 or first client device 135 may perform CCA sensing over both punctured and unpunctured channels, except, if it can lower its emissions over a punctured channel by X dB, then it can relax (raise) its CCA threshold by X dB for that punctured channel. The relaxation value may be signaled in the punctured subchannel CCA required field. For example, the punctured subchannel CCA required field may have other values, one per calculation method, defined such as 1, 2, or 3 to indicate a value of 10, 15, or 20 dB respectively. Similarly, the punctured subchannel CCA field may be a bitmap with 1 bit per calculation method to indicate support for that method or not.

In some examples, the relaxation value (that is, X) may be defined as a fixed number (for example, 20 db) or may be chosen by the station. In various embodiments, X may be calculated as the min, mean-in-power, or mean-in-dB of the Transmit (TX) Power Spectral Density (PSD) suppression. In other words the relaxation value may comprise a minimum of an amount that first AP 115 or the station can suppress its TX PSD for the punctured subchannel, a mean-in-power of the amount that first AP 115 can suppress its TX PSD for the punctured subchannel, or a mean-in-dB of the amount that first AP 115 can suppress its TX PSD for the punctured subchannel for example. Client devices and APs may signal to one another their capability to relax (raise) their CCA threshold by X dB for a punctured channel.

Consistent with other embodiments, the station may perform CCA sensing over both punctured and unpunctured channels, except, if the station can lower its emissions over a punctured channel by X dB, then it can relax (raise) its CCA threshold by a factor (for example, (rho)*X) dB for that punctured channel, where 0<rho<1. For example, using the above example, if rho=0.5, and the CCA threshold is [-62-62-62-62] dBm, but the STA can suppress its TX PSD by 20 dB over the punctured channel, then the STA would defer at [-62-62-52-62] dBm. In this example, the energy detection CCA threshold to go from -62 dBm to-52 dBm for the S40a subchannel.

In some example embodiments, the station may perform CCA sensing over both punctured and unpunctured channels. The station may not get any CCA relaxation over any punctured channel. A legacy station may signal the second indication comprising the bit value in the punctured subchannel CCA as 0. A station that is capable of performing CCA in modified way by raising CCA threshold by a fixed amount X dB may signal the second indication comprising the bit value in the punctured subchannel CCA as 1. An AP (for example, first AP) that may require CCA in modified way by raising CCA threshold by a fixed amount X dB may signal the first indication comprising the bit value in the punctured subchannel CCA as 1. A station that is also capable of performing CCA in modified way by raising CCA threshold by a parameter-based amount rho*X dB may signal the second indication comprising a bit map in the punctured subchannel CCA as [1 1]. An AP, for example, first AP, that may require performing CCA in modified way by raising CCA threshold by a parameter-based amount rho*X dB may signal the first indication comprising the bit value in the punctured subchannel CCA required as 2.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for providing a LPI AP CCA signaling schemes for seamless preamble puncturing support as described above with respect to FIG. 2. Computing device 300, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
signaling, by an Access Point (AP), a first indication that the AP supports punctured subchannel Clear Channel Assessment (CCA);
receiving, by the AP, a second indication from a station whether the station supports the punctured subchannel CCA; and
determining, by the AP, a nature of association between the AP and the station based on the second indication.

2. The method of claim 1, wherein signaling, by the AP, first the indication that the AP supports the punctured subchannel CCA comprises signaling, by the AP, the first indication that the AP supports the punctured subchannel CCA in an Extremely High Throughput (EHT) operation element or in an Ultra High Reliability (UHR) operation element.

3. The method of claim 1, wherein receiving, by the AP, the second indication from the station that the station supports the punctured subchannel CCA comprises receiving the second indication in an EHT capability element or in an UHR capability element.

4. The method of claim 1, wherein determining the nature of association between the AP and the station based on the second indication comprises:
disallowing the station to associate with the AP in response to the second indication indicating that the station does not support the punctured subchannel CCA.

5. The method of claim 1, wherein determining the nature of association between the AP and the station based on the second indication comprises:
allowing the station to associate with the AP at a lower bandwidth that is entirely unpunctured in response to the second indication indicating that the station does not support the punctured subchannel CCA.

6. The method of claim 1, wherein determining the nature of association between the AP and the station based on the second indication comprises:
allowing the station to associate with the AP at a full bandwidth that includes punctured channels in response to the second indication indicating that the station does support the punctured subchannel CCA.

7. The method of claim 1, further comprising:
signaling a relaxation value for the punctured subchannel CCA, wherein an energy detection CCA threshold is changed by the relaxation value for a punctured subchannel.

8. The method of claim 7, wherein signaling the relaxation value comprises signaling a code that corresponds to a predetermined value for the relaxation value.

9. A system comprising:
a memory storage; and
a processing unit disposed in a computing device coupled to the memory storage, wherein the processing unit is operative to:
signal a first indication that an Access Point (AP) supports punctured subchannel Clear Channel Assessment (CCA);
receive a second indication from a station whether the station supports the punctured subchannel CCA; and
determine a nature of association between the AP and the station based on the second indication.

10. The system of claim 9, wherein the processing unit being operative to signal the first indication that the AP supports the punctured subchannel CCA comprises the processing unit being operative to signal the first indication that the AP supports the punctured subchannel CCA in an Extremely High Throughput (EHT) operation element or in an Ultra High Reliability (UHR) operation element.

11. The system of claim 9, wherein the processing unit being operative to receive the second indication from the station that the station supports the punctured subchannel CCA comprises the processing unit being operative to receive the second indication in an EHT capability element or in an UHR capability element.

12. The system of claim 9, wherein the processing unit being operative to determine the nature of association between the AP and the station based on the second indication comprises the processing unit being operative to:
disallow the station to associate with the AP in response to the second indication indicating that the station does not support the punctured subchannel CCA.

13. The system of claim 9, wherein the processing unit being operative to determine the nature of association between the AP and the station based on the second indication comprises the processing unit being operative to:
allow the station to associate with the AP at a lower bandwidth that is entirely unpunctured in response to the second indication indicating that the station does not support the punctured subchannel CCA.

14. The system of claim 9, wherein the processing unit being further operative to:
signal a relaxation value for the punctured subchannel CCA, wherein an energy detection CCA threshold is changed by the relaxation value for a punctured subchannel.

15. A non-transitory computer-readable medium that stores a set of instructions which when executed perform a method executed by the set of instructions comprising:
signaling, by an Access Point (AP), a first indication that the AP supports punctured subchannel Clear Channel Assessment (CCA);
receiving, by the AP, a second indication from a station whether the station supports the punctured subchannel CCA; and
determining, by the AP, a nature of association between the AP and the station based on the second indication.

16. The non-transitory computer-readable medium of claim 15, signaling, by the AP, the first indication that the AP supports the punctured subchannel CCA comprises signaling, by the AP, the first indication that the AP supports the punctured subchannel CCA in an Extremely High Throughput (EHT) operation element or in an Ultra High Reliability (UHR) operation element.

17. The non-transitory computer-readable medium of claim 15, wherein receiving, by the AP, the second indication from the station that the station supports the punctured subchannel CCA comprises receiving the second indication in an EHT capability element or in an UHR capability element.

18. The non-transitory computer-readable medium of claim 15, wherein determining the nature of association between the AP and the station based on the second indication comprises:
disallowing the station to associate with the AP in response to the second indication indicating that the station does not support the punctured subchannel CCA.

19. The non-transitory computer-readable medium of claim 15, wherein determining the nature of association between the AP and the station based on the second indication comprises:
allowing the station to associate with the AP at a lower bandwidth that is entirely unpunctured in response to the second indication indicating that the station does not support the punctured subchannel CCA.

20. The non-transitory computer-readable medium of claim 15, further comprising:
signaling a relaxation value for the punctured subchannel CCA, wherein an energy detection CCA threshold is changed by the relaxation value for a punctured subchannel.
